(19) United States
(12) Patent Application Publication
(10) Pub. No.: US 2004/0213161 A1
(43) Pub. Date: Oct. 28, 2004

(54) Integrated circuit powered with link pulse energy

(76) Inventor: David S. Nack, Roseville, CA (US)

Correspondence Address: BUCKLEY, MASCHOFF, TALWALKAR LLC, 5 ELM STREET, NEW CANAAN, CT, 06840, US

(21) Appl. No.: 10/420,177

(22) Filed: Apr. 22, 2003

(51) Int. Cl. H04L 12/26

(52) U.S. Cl. 370/249

(57) ABSTRACT

According to some embodiments, an integrated circuit is powered with link pulse energy.

### BACKGROUND

A device may need to perform a function even when power is not supplied to the device's a power supply connection. For example, FIG. 1 is a block diagram illustrating a known system 100 including an Ethernet switch 110 and an Internet Packet (IP) telephone 120.

The Ethernet switch 110 may, for example, process information in accordance with the Fast Ethernet Local Area Network (LAN) transmission standard 802.3-2002® published by the Institute of Electrical and Electronics Engineers (IEEE). Moreover, the IP telephone 120 may be coupled to the Ethernet switch 110 with an Ethernet cable.

The Ethernet switch 110 may need to discover if it is currently coupled to an IP telephone (as opposed to some other type of device) even when power is not supplied to the IP telephone 120. To do so, the Ethernet switch 110 may transmit a stream of pulses to the IP telephone 120 (e.g., a pseudo-random series including both narrow and wide Ethernet “link” pulses).

A mechanical switching mechanism in a relay 140 may be configured to loop-back the stream of link pulses to the Ethernet switch when power is not supplied to the IP telephone 120. Note that when power is supplied to the IP telephone 120, the relay 140 may instead arrange to have an integrated circuit 130 process information being exchanged the Ethernet switch 110 (e.g., a transceiver may facilitate the normal operation of the IP telephone 120).

A passive filter 150 may remove narrow link pulses from the signal that is looped-back to the Ethernet switch 110 (leaving only the wide link pulses). The Ethernet switch 110 may then compare the looped-back signal with the original stream of link pulses. If the looped-back signal matches the original stream (without the narrow link pulses), the Ethernet switch may determine that it is currently coupled to an IP telephone.

In addition to increasing the cost of the IP telephone 120, the discrete (off-chip) relay 140 and passive filter 150 may reduce the reliability of the system 100 (e.g., a mechanical switching mechanism may have a relatively high failure rate as compared to an integrated circuit).

### BRIEF DESCRIPTION OF THE DRAWINGS

FIG. 1 is a block diagram illustrating a known system.

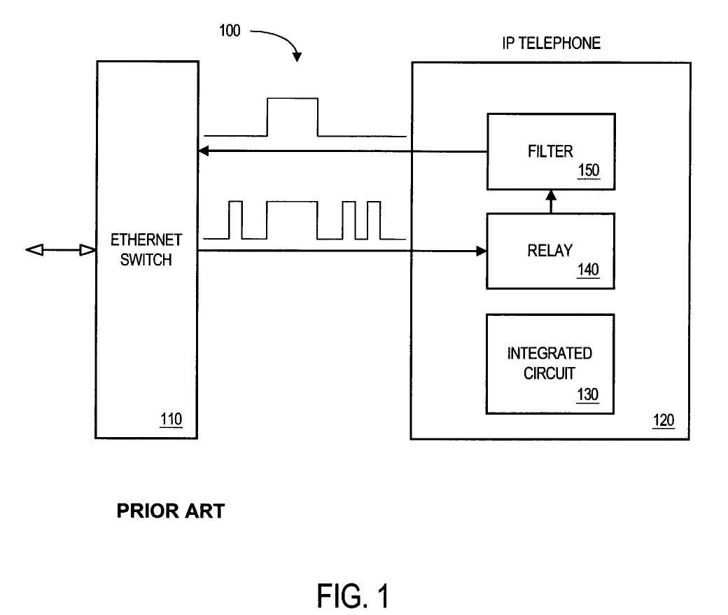

FIG. 2 is a block diagram of an integrated circuit according to some embodiments.

FIG. 3 is a flow chart of a method that may be performed by an integrated circuit according to some embodiments.

FIG. 4 is a block diagram of an integrated circuit according to some embodiments.

FIG. 5 illustrates streams of link pulses according to some embodiments.

FIG. 6 is a flow chart of a method that may be performed by an integrated circuit according to some embodiments.

FIG. 7 is an example of a portion of an integrated circuit according to one embodiment.

FIG. 8 is a block diagram of a system according to some embodiments.

### DETAILED DESCRIPTION

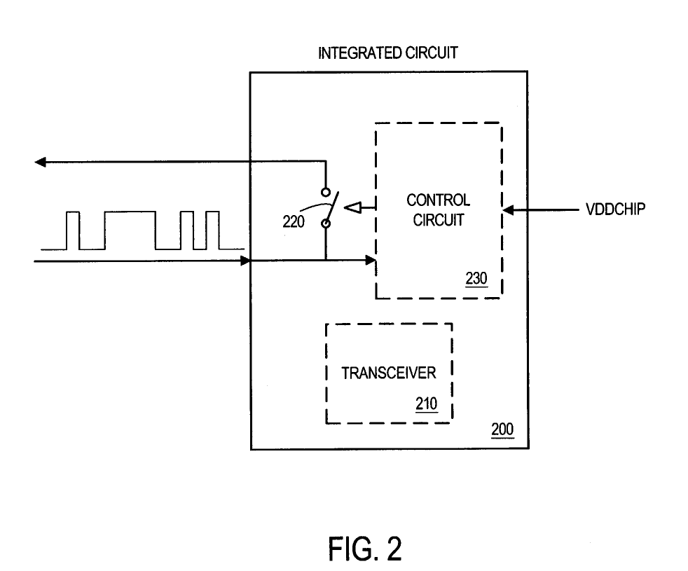

FIG. 2 is a block diagram of an integrated circuit 200 according to some embodiments. The integrated circuit 200 receives an input signal via an input path, provides an output signal via an output path, and is powered via a power supply connection VDDCHIP. The integrated circuit 200 also includes a processing portion, such as a transceiver portion 210 adapted to perform operations associated with the physical layer of an IP telephone or other packet-switched device (e.g., a device that exchanges voice, facsimile, and/or image information using a flow of data packets transmitted via a line shared with other devices).

The integrated circuit 200 further includes a loop-back portion that selectively loops-back an input signal to the output path. In particular, a switch 220 may selectively couple the input path to the output path based on a control signal generated by a control circuit 230. The control circuit 230 may, for example, close the switch 220 when VDDCHIP is not present (so that the input signal will be looped-back) and open the switch 220 when VDDCHIP is present (so that the transceiver portion 210 can facilitate a normal exchange of information via the input and output paths). According to this embodiment, at least part of the control circuit 230 is powered with energy from the input signal.

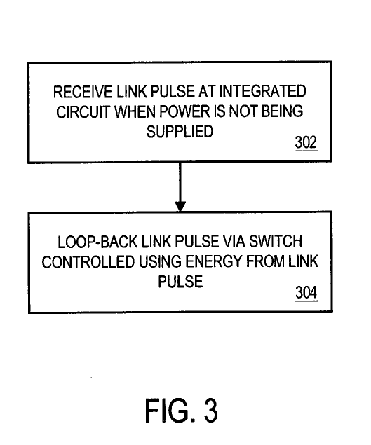

FIG. 3 is a flow chart of a method that may be performed by an integrated circuit according to some embodiments. The flow charts described herein do not necessarily imply a fixed order to the actions, and embodiments may be performed in any order that is practicable. The method of FIG. 3 may be associated with, for example, the integrated circuit 200 illustrated in FIG. 2. Note that any of the methods described herein may be performed by hardware, software (including microcode), or a combination of hardware and software. For example, a storage medium may store thereon instructions that when executed by a machine result in performance according to any of the embodiments described herein.

At 302, a link pulse is received at an integrated circuit when power is not being supplied to the integrated circuit's power supply connection. For example, an integrated circuit in an IP telephone may receive a stream of link pulses from an Ethernet switch via an Ethernet cable. Although Ethernet devices are described herein, other embodiments may be associated with other network protocols.

At 304, the link pulse is looped-back to an output path via a switch within the integrated circuit. For example, some or all of the link pulses might be transmitted back to the Ethernet switch via the Ethernet cable. Moreover, the switch within the integrated circuit may be controlled using energy from the link pulse.

Because a mechanical switching mechanism in an off-chip relay may be avoided, the cost of a system associated with the integrated circuit 200 may be reduced and/or reliability may be improved.

### Link Pulse Filtering

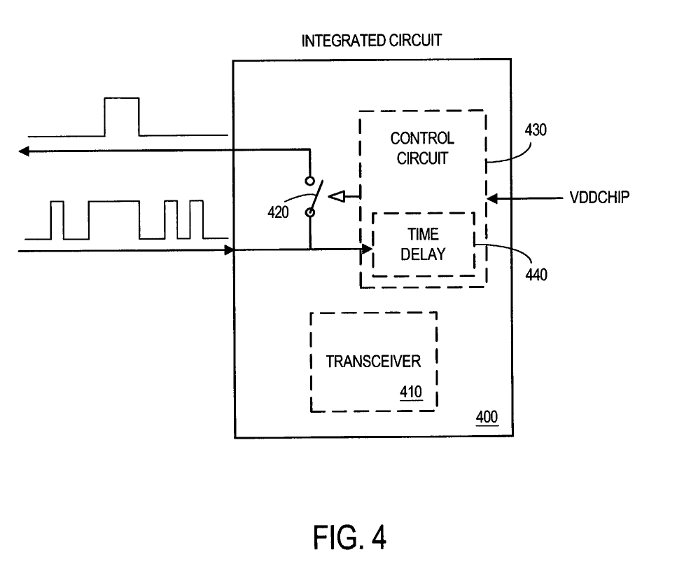

FIG. 4 is a block diagram of an integrated circuit 400 according to some embodiments. As before, the integrated circuit 400 receives an input signal via an input path, provides an output signal via an output path, and is powered via a power supply connection VDDCHIP. The integrated circuit 400 also includes a transceiver portion 410 to perform operations associated with the physical layer of an IP telephone.

The integrated circuit 400 further includes a switch 420 controlled by a control circuit 430. The control circuit 430 may, for example, open the switch 420 when VDDCHIP is present (so that the transceiver portion 410 can facilitate a normal exchange of information via the input and output paths) and at least part of the control circuit 430 may be powered with energy from the input signal.

According to this embodiment, the control circuit 430 further includes a filtering circuit that prevents an input signal from being looped-back through the switch 420 (even when VDDCHIP is not present). For example, a time delay portion 440 may filter out narrow link pulses while allowing wide link pulses to be looped-back through the switch 420.

That is, the switch 420 may always be open when VDDCHIP is present. When VDDCHIP is not present and the input signal is low, the switch 420 may also be open. When VDDCHIP is not present and the input signal transitions to high, the time delay portion 440 arranges for the switch 420 to still remain open for a period of time. After that period of time, the switch 420 may close and the input signal is looped-back to the output path of the integrated circuit 400 (assuming VDDCHIP is still not present and the input signal is still high). According to some embodiments, energy from the link pulse is stored during this delay (e.g., to be used after the delay to power at least part of the control circuit 430 and/or switch 420).

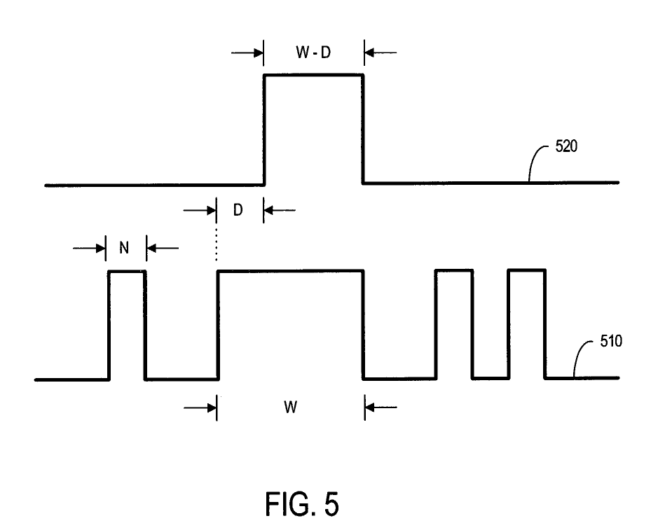

Consider the stream 510 of link pulses illustrated in FIG. 5 that might be received via the input path. The received stream 510 includes narrow link pulses each having a width N (e.g., a narrow link pulse may be a standard 100 nsec 10BaseT Ethernet link pulse) and wide link pulses each having a width W (e.g., a 1000 nsec).

Moreover, assume the time delay portion 440 described with respect to FIG. 4 keeps the switch 420 open for a period of time D (e.g., 300 nsec) after the input signal transitions to high. In this case, the signal that is looped-back to the output path is illustrated by stream 520. Note that because D is greater than N, narrow link pulses cannot pass through the switch 420. Moreover, because D is less than W, at least a portion of each wide link pulse does pass through the switch 420. In particular, a wide link pulse will be looped-back as a pulse delayed by D and having a width of W-D (e.g., 1000 nsec −300 nsec=700 nsec).

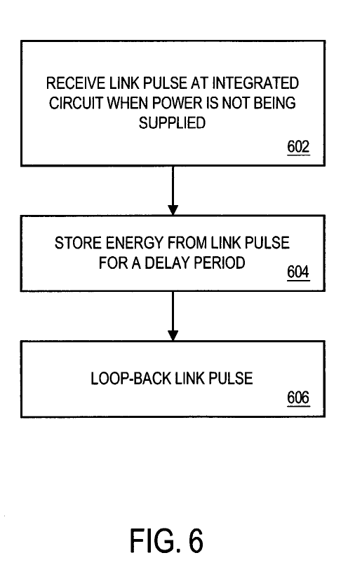

FIG. 6 is a flow chart of a method that may be performed by an integrated circuit according to some embodiments. At 602, a link pulse is received at the integrated circuit when power is not being supplied to the integrated circuit. During a delay period, energy from the link pulse may be stored at 604 (e.g., in a capacitor). After the delay period, the stored energy may be used to loop-back the received link pulse at 606 (assuming the link pulse was wider than the delay period and that power is still not supplied to the integrated circuit).

Because the use of an off-chip passive filter may be avoided, the cost of a system associated with the integrated circuit 400 may be reduced and/or reliability may be improved.

### EXAMPLE

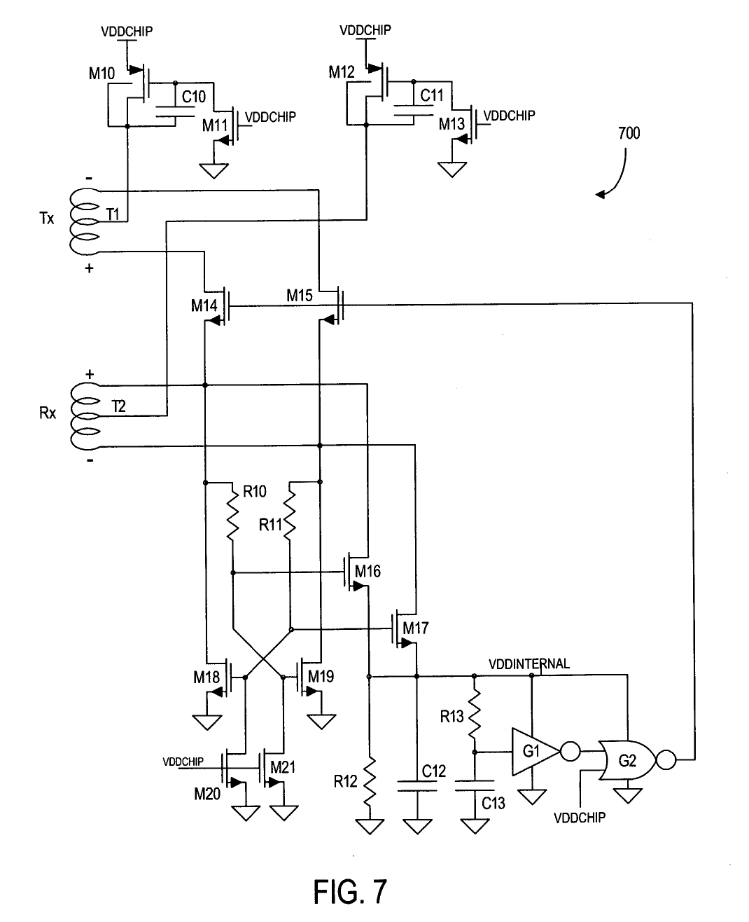

FIG. 7 is an example of a portion 700 of an integrated circuit according to one embodiment. In this case, the input path is differential input Rx and the output path is differential output Tx. Note that each differential interface has a positive tap, a center tap and a negative tap. Rx and Tx may represent, for example, the silicon side of transformers that isolate an Ethernet cable from the silicon of the integrated circuit.

When power is not supplied from the chip's power supply connection, VDDCHIP is 0 volts. As a result, all node voltages will be 0 volts and all transistors will be off (prior to the arrival of a link pulse).

The loop-back switch in the circuit comprises (i) a transistor M14, such as a Metal Oxide Semiconductor (MOS) transistor, coupled to the positive taps of Rx and Tx and (ii) a transistor M15 coupled to the negative taps of Rx and Tx. The control of this loop-back switch will now be described.

According to some embodiments, the circuit can detect differential link pulses of either polarity. For example, a link pulse may be received such that the positive tap of Rx has a positive voltage and the negative tap of Rx has a negative voltage. Similarly, a link pulse may be received such that the positive tap of Rx has a negative voltage and the negative tap of Rx has a positive voltage.

Moreover, according to some embodiments a voltage level associated with the positive side of a differential link pulse is increased as follows: (i) the positive tap of Rx is held to a pre-determined voltage level (e.g., 0 volts) when a positive voltage is detected at the negative tap, and (ii) the negative tap of Rx is held to that voltage level if a positive voltage is detected at the positive tap. In this way, a signal that would otherwise be received as −1 volt at one tap and +1 volt at the other tap is instead 0 volts at one tap and 2 volts at the other tap.

In addition, a termination impedance associated with the integrated circuit may be removed (e.g., when VDDCHIP is not present) to increase the voltage associated with a link pulse to a level greater than the level that result when the termination impedance is present.

Consider, for example, a link pulse that is received such that the positive tap of Rx has a positive voltage and the negative tap of Rx has a negative voltage. Moreover, assume that difference between these voltages is typically be 2.5 volts when a receive termination is present. If the lack of VDDCHIP removes this receive termination, the difference between the differential voltages may increase (e.g., to 5 volts). Note that if transistors M18 and M19 were not present in the circuit, the 5 volt pulse would result in transistor M16's gate going to +2.5 volts and transistors M17's gate going to −2.5 volts.

When transistors M18 and M19 are included in the circuit, the positive side of the differential signal may turn on transistor M19. As transistor M19 turns on, negative tap of Rx will be held to 0 volts. Assuming that the center-tap is allowed to float, this will result in transistor M16's gate going to 5 volts and transistor M17's gate going to 0 volts. An internal voltage VDDINTERNAL will then charge up to almost 5 volts (e.g., VDDINTERNAL might reach 4.8 volts), and this energy can be stored in capacitor C12.

According to some embodiments, resistor R13 and capacitor C13 introduce a delay, such as a 300 nsec delay. In this case, a 100 nsec link pulse would not cause the inverter G1's input to reach its threshold, and NOR gate G2 will hold the gates of transistors M14 and M15 low (the loop-back switch is open). In contrast, a 1000 nsec link pulse will cause inverter G1 to switch (after 300 nsec), forcing the gates of transistors M14 and M15 to 4.8 volts (closing the loop-back switch).

When the loop-back switch is closed, the receive termination resistors of the integrated circuit may return, causing the amplitude of the Rx signal to fall back to the normal 2.5 volt level. However, capacitor C12 is still holding VDDINTERNAL at 4.8 volts, and therefore NOR gate G2 is supplying 4.8 volts to the gates of transistors M14 and M15. Since transistors M14 and M15 may have a threshold of less than 1 volt, this can provide sufficient gate drive to loop-back the full 2.5 volt signal to Tx. As a result, an external Ethernet switch may see the same 2.5 link pulse that it had originally transmitted to the integrated circuit (except 300 nsec will be removed from the leading edge).

Resistor R12 may bleed off VDDINTERNAL so that it decays to 0 volts prior to the reception of the next link pulse (e.g., 60 usec later).

When power is applied to the integrated circuit (VDDCHIP goes high), transistors M20 and M21 may force transistors M16, M17, M18, and M19 off and VDDINTERNAL to 0 volts. As a result, the gates of transistors M14 and M15 are held low so that the integrated filter and switch functions will not interfere with the normal operation of integrated circuit.

According to some embodiments, the center taps of Rx and Tx are driven to VDDCHIP during normal operation (transistors M10 and M11 turn on when VDDCHIP is present) and the center taps float when VDDCHIP is not present (transistors M10 and M11 are off). Note that the bulk connections of transistors M10 and M11 may be made to the center tap (e.g., so that the parasitic diode does not turn on when VDDCHIP is not present). When VDDCHIP is not present, transistors M11 and M13 are off, and capacitors C10 and C11 force the gates of transistors M10 and M11 to track its drain voltages, thereby keeping the transistors M10 and M11 off.

Note that the threshold voltages and sizing of the resistors, capacitors and transistors described in this example may be chosen to ensure desired operation over a number of potential cable and temperature conditions.

### System

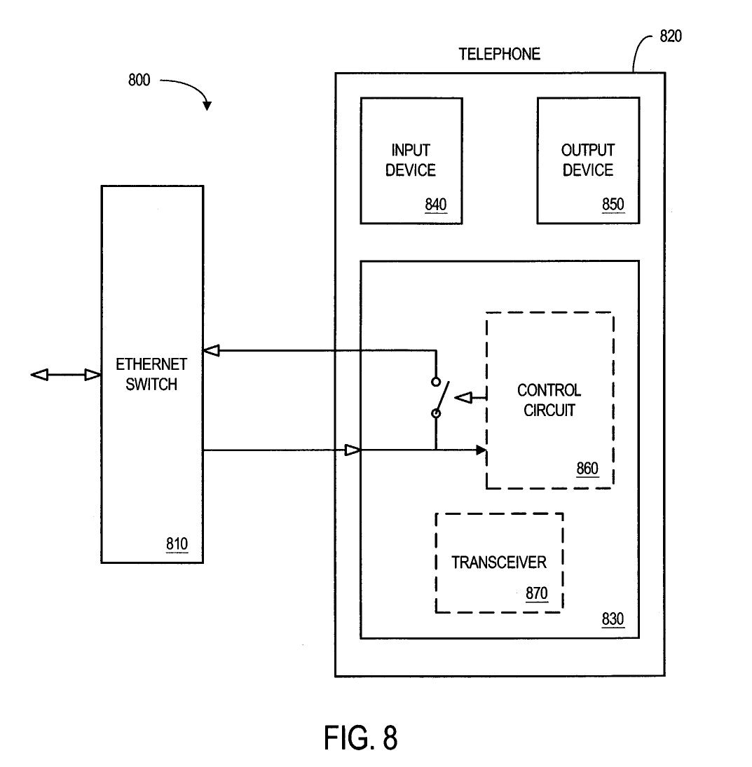

FIG. 8 is a block diagram of a system 800 according to some embodiments. The systems includes an Ethernet switch 810 coupled to an IP telephone 820 with an Ethernet cable. The Ethernet switch 810 may, for example, facilitate an exchange information between the telephone 820 and a network (e.g., the Internet).

The telephone 820 may include an integrated circuit 830, one or more input devices 840 (e.g., a microphone and a keypad), and one or more output devices 850 (e.g., a speaker). The integrated circuit 830 may operate in accordance with any of the embodiments described herein (e.g., a control circuit 860 may determine whether a link pulse will be looped-back to the Ethernet switch 810, and at least part of the control circuit 860 may be powered with energy from the link pulse). The integrated circuit 830 may further include portions to perform operations associated with the telephone 820 (e.g., a transceiver portion 870 may process information associated with the physical layer of the telephone 810).

According to another embodiment, the telephone 820 is connected directly to the Internet (i.e., no Ethernet switch 810 is present).

### Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

A number of embodiments have been described herein, and each of these embodiments might be implemented alone or in combination with other embodiments. For example, an integrated circuit might use a time delay to filter out narrow link pulses but not power a control circuit with energy from a link pulse. In addition, a filtering circuit might accept narrow pulses while preventing wide pulses from being looped-back to an Ethernet switch (or filter out any other type of information).

Moreover, although particular examples have been described, other implementations and/or additional features might be provided. For example, an integrated circuit might incorporate enhancements to reduce cross-talk that might be introduced by transistors M14 and M15 in FIG. 7, to provide hysteresis on the comparator, and/or to filter the center taps.

The several embodiments described herein are solely for the purpose of illustration. Persons skilled in the art will recognize from this description other embodiments may be practiced with modifications and alterations limited only by the claims.

What is claimed is:

1. An apparatus, comprising:
a processing portion of an integrated circuit to perform processing associated with a physical layer; and
a loop-back portion of the integrated circuit, comprising:
a switch to selectively loop-back a received link pulse, and
a control circuit to control whether the switch is to loop-back the link pulse, wherein at least part of the control circuit is powered with energy from the link pulse.

2. The apparatus of claim 1, wherein a received link pulse is looped-back through the switch when power is not being supplied to the integrated circuit's power supply connection.

3. The apparatus of claim 1, wherein the loop-back portion further comprises:
a filtering circuit.

4. The apparatus of claim 3, wherein the filtering circuit is associated with a time delay switch.

5. The apparatus of claim 4, wherein at least part of the filtering circuit is powered with energy from the link pulse.

6. The apparatus of claim 1, wherein the loop-back portion further comprises:
a differential input to receive the link pulse, and
a differential output to provide the looped-back link pulse.

7. The apparatus of claim 6, wherein the switch includes a first transistor coupled to a first tap of the differential output a second transistor coupled to a second tap of the differential output.

8. The apparatus of claim 6, wherein the differential input includes a positive tap and a negative tap, and:
the positive tap is to be held to a pre-determined voltage level if a positive signal is detected at the negative tap, and
the negative tap is to be held to a pre-determined voltage level if a positive signal is detected at the positive tap.

9. The apparatus of claim 1, wherein a termination impedance associated with the integrated circuit is removed to increase the voltage of the energy to a level greater than a voltage associated with the link pulse when the termination impedance is present.

10. The apparatus of claim 1, wherein the received link pulse is associated with an Ethernet interface.

11. The apparatus of claim 1, wherein the processing portion of the integrated circuit is associated with at least one of (i) a transceiver, (ii) an Ethernet device, and (iii) an Internet packet telephone.

12. The apparatus of claim 1, wherein the loop-back portion of the integrated circuit is associated with a discovery process.

13. An apparatus, comprising:
a processing portion of an integrated circuit to perform processing associated with a physical layer; and
a loop-back portion of the integrated circuit, including:
a switch to selectively loop-back a received link pulse, and
a filtering circuit, wherein at least part of the filtering circuit is powered with energy from the link pulse.

14. The apparatus of claim 13, wherein the filtering circuit is associated with a time delay switch.

15. The apparatus of claim 13, wherein a termination impedance associated with the integrated circuit is removed to increase the voltage of the energy to a level greater than a voltage associated with the link pulse when the termination impedance is present.

16. An apparatus, comprising:
a first portion of an integrated circuit to perform processing associated with a physical layer; and
a second portion of the integrated circuit to receive a link pulse, wherein (i) at least part of the second portion is powered with energy from the link pulse and (ii) a termination impedance associated with the integrated circuit is removed to increase the voltage of the energy to a level greater than a voltage associated with the link pulse when the termination impedance is present.

17. The apparatus of claim 16, wherein the processing portion of the integrated circuit is associated with at least one of (i) a transceiver, (ii) an Ethernet device, and (iii) an Internet packet telephone.

18. A method, comprising:
receiving a link pulse at an integrated circuit when power is not being supplied to the integrated circuit's power supply connection;
storing energy from the link pulse for a delay period; and
after the delay period, using the stored energy to control a switch that loops-back the received link pulse.

19. The method of claim 18, further comprising:
arranging for the switch to be open when power is being supplied to the integrated circuit's power supply connection.

20. A system, comprising:
a telephone, comprising:
a transceiver portion of an integrated circuit to perform processing associated with a physical layer, and
a loop-back portion of the integrated circuit, comprising:
a switch to selectively loop-back a received link pulse, and
a control circuit to control whether the switch is to loop-back the link pulse, wherein at least part of the control circuit is powered with energy from the link pulse; and
an Ethernet switch coupled to the telephone and a communication network.

21. The system of claim 20, wherein the communication network is the Internet.
